(19) United States
(12) Patent Application Publication
(10) Pub. No.: US 2011/0147468 A1
(43) Pub. Date: Jun. 23, 2011

(54) RFID TAG

(75) Inventors: Ji Man PARK, Daejeon (KR); Lee Mi Do, Daejeon (KR); Kyu Ha Baek, Daejeon (KR); Kun Sik Park, Daejeon (KR); Dong Pyo Kim, Gwangmyeong (KR)

(73) Assignee: Electronics and Telecommunications Research Institute, Daejeon (KR)

(21) Appl. No.: 12/970,394

(22) Filed: Dec. 16, 2010

(30) Foreign Application Priority Data
Dec. 18, 2009 (KR) 10-2009-0126655
Nov. 24, 2010 (KR) 10-2010-0117612

(51) Int. Cl. G06K 19/073

(52) U.S. Cl. 235/492

(57) ABSTRACT

Provided is a radio frequency identification (RFID) tag whose data can be stably read at a long distance on the basis of a passive RFID tag. The RFID tag includes a rechargeable unit charged to a predetermined voltage, and a power source including a direct current (DC) power source including a rectifier for converting an RF signal into DC power and a regulator for supplying a predetermined DC voltage, an interceptor disposed between the rechargeable unit and the DC power source to connecting or disconnecting the power to the rechargeable unit, and an overvoltage preventor connected to an output terminal of the DC power source in parallel.

### CROSS-REFERENCE TO RELATED APPLICATION

This application claims priority to and the benefit of Korean Patent Application Nos. 10-2009-0126655 filed Dec. 18, 2009, and 10-2010-0117612, filed Nov. 24, 2010, the disclosure of which is incorporated herein by reference in its entirety.

### BACKGROUND

1. Field of the Invention

The present invention relates to a radio frequency identification (RFID) tag, and more particularly to an RFID tag in which a rechargeable battery is embedded on the basis of a passive RFID tag and thus whose data can be stably read at a long distance.

2. Discussion of Related Art

In general, RFID technology allows information to be read from or recorded to a tag having unique ID information using an RF without contact, so that products, animals, persons, etc. to which tags are attached can be recognized, traced and managed. Such an RFID system includes an RFID tag having unique ID information and attached to a product, animal, etc., and an RFID reader for reading or writing information that the RFID tag has.

RFID tags are generally classified into active RFID tags and passive RFID tags. While active RFID tags contain an external power source (e.g., a battery, or a lithium-ion battery), passive RFID tags internally generate and obtain power from an RF signal received through an antenna.

Active RFID tags have a longer read distance and a stronger radio signal than passive RFID tags, and thus can have a high recognition rate. However, an external power source of the active RFID tags increases their size and weight, and needs to be replaced when the power of the power source is consumed. In other words, active RFID tags have problems in terms of manufacturing, management, and cost.

Passive RFID tags can be reduced in size, and have advantages in terms of manufacturing, management, and cost in comparison with active RFID tags. However, passive RFID tags have a shorter read distance than active RFID tags.

### SUMMARY OF THE INVENTION

As mentioned above, passive radio frequency identification (RFID) tags have a shorter read distance than active RFID tags but significant advantages in terms of manufacturing, management, and cost. For this reason, the present invention is directed to providing an RFID tag whose data can be stably read at a long distance on the basis of a passive RFID tag.

One aspect of the present invention provides an RFID tag including: a rechargeable unit charged to a predetermined voltage; a direct current (DC) power source for generating power from an RF signal; an interceptor disposed between the DC power source and the rechargeable unit, and connecting or disconnecting the power to the rechargeable unit; and an overvoltage preventor connected to an output terminal of the DC power source and connected with the rechargeable unit in parallel to prevent the rechargeable unit from being charged to an overvoltage.

The DC power source may include a rectifier for converting the RF signal received by an antenna into DC power; and a regulator for supplying a predetermined DC voltage.

The interceptor may be a switch circuit.

The overvoltage preventor may be a diode circuit.

Another aspect of the present invention provides an RFID tag including: a rechargeable unit charged to a predetermined voltage; a DC power source for generating power from an RF signal; an interceptor disposed between the DC power source and the rechargeable unit, and connecting or disconnecting the power to the rechargeable unit; an overvoltage preventor connected to an output terminal of the DC power source and connected with the rechargeable unit in parallel to prevent the rechargeable unit from being charged to an overvoltage; and a power supply and solar cell connected to the output terminal of the DC power source. The RFID tag may be charged by the power generated by the DC power source, external power connected through the power supply, or power generated from the solar cell.

The RFID tag may further include an indicator for indicating pieces of information relating to the RFID tag.

The RFID tag may further include a sensor for recognizing pieces of information relating to the RFID tag.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIGS. 1A and 1B schematically show constitutions of radio frequency identification (RFID) tags according to exemplary embodiments of the present invention;

FIG. 2 shows a detailed constitution of a power source of the RFID tags shown in FIGS. 1A and 1B according to exemplary embodiments of the present invention;

FIG. 3 shows a constitution of the RFID tag shown in FIG. 1B to which a power supply and a solar cell are added;

FIG. 4 illustrates connections of the power supply, the solar cell, and a rechargeable unit of the RFID tag shown in FIG. 3 according to an exemplary embodiment of the present invention;

FIG. 5 shows a constitution of the RFID tag shown in FIG. 3 to which an indicator and a sensor are added; and

FIG. 6 is a flowchart illustrating a method of charging a rechargeable unit in an RFID tag according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

A radio frequency identification (RFID) tag according to an exemplary embodiment of the present invention will be described in detail below with reference to the appended drawings.

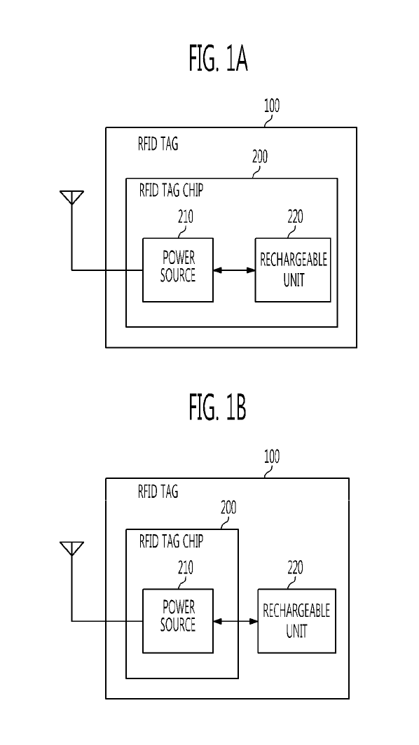

First, FIGS. 1A and 1B schematically show constitutions of RFID tags 100 according to exemplary embodiments of the present invention. In FIGS. 1A and 1B, general components of RFID tags are omitted to aid in understanding constitutional features of the present invention. For example, components converting an RF signal into a digital signal or vice versa, components reading a signal transmitted from an RFID reader and transmitting a signal corresponding the signal, and predetermined memory components are included, but detailed description of these components will be omitted.

Referring to FIG. 1A, the RFID tag 100 according to an exemplary embodiment of the present invention may include an RFID tag chip 200 having a power source 210 and a rechargeable unit 220. The rechargeable unit 220 according to an exemplary embodiment of the present invention may be embedded in the RFID tag chip 200 when the RFID tag chip 200 is manufactured. FIG. 1B shows the RFID tag 100 according to another exemplary embodiment of the present invention in which the rechargeable unit 220 is disposed outside the RFID tag chip 200 and connected to the power source 210 of the RFID tag chip 200.

The rechargeable unit 220 may be implemented into a rechargeable battery. Such a rechargeable battery can be manufactured in a variety of forms according to the shape of an RFID tag and the shape of an RFID tag chip. For example, the rechargeable unit 220 can be implemented into a thin film rechargeable battery when the RFID tag 100 is a card-type tag, and implemented into a rechargeable battery appropriately formed for the thickness of the RFID tag and embedded in the RFID tag when the RFID tag has a predetermined thickness. In an exemplary embodiment of the present invention, the rechargeable unit 220 may be charged by RF power resulting from general request/response communication between an RFID reader and the RFID tag 100. In another exemplary embodiment, the RFID reader may transmit RF power to charge the RFID tag 100, and thereby the rechargeable unit 220 can be charged.

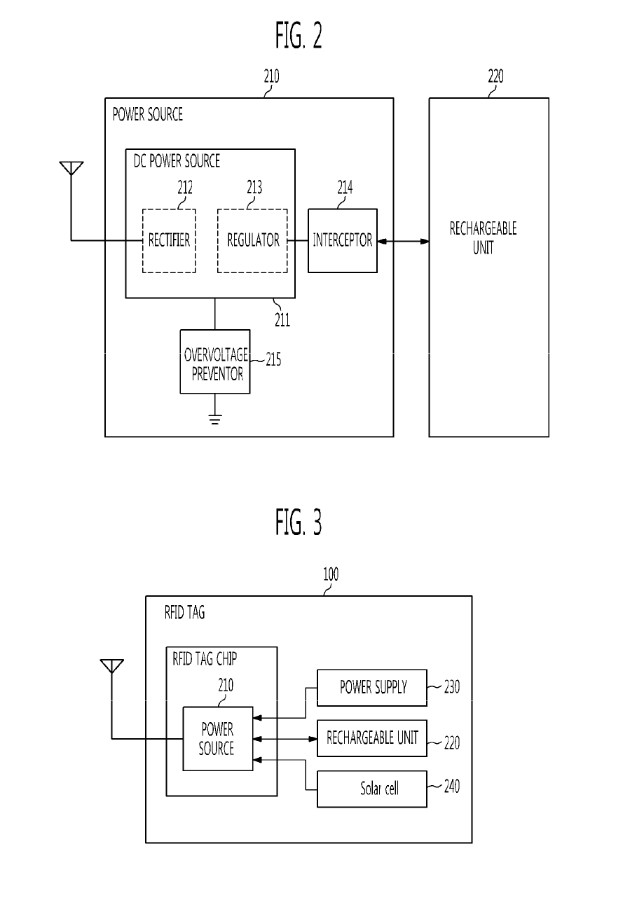

The power source 210 generates power from an RF signal received from an antenna and provides the generated power to components of the RFID tag 100. FIG. 2 shows a detailed constitution of the power source 210 according to an exemplary embodiment of the present invention. The power source 210 includes a direct current (DC) power source 211 including a rectifier 212 converting a carrier frequency signal of an RF signal received by an antenna into DC power and a regulator 213 for supplying a predetermined DC voltage to the components of the RFID tag 100, an interceptor 214 disposed between the rechargeable unit 220 and the DC power source 211 to connecting or disconnecting the power to the rechargeable unit 220, and an overvoltage preventor 215 connected to an output terminal of the DC power source 211 in parallel. The overvoltage preventor 215 may be a diode circuit, a complementary metal-oxide semiconductor (CMOS) circuit, etc., and the interceptor 214 may be a switch circuit. In an exemplary embodiment, the overvoltage preventor 215 and the interceptor 214 may be implemented into CMOS circuits. The overvoltage preventor 215 and the interceptor 214 designed in this way can have almost no influence on the size of the RFID tag chip 200. When the RFID tag 100 is used, the interceptor 214 connects the power source 210 and the rechargeable unit 220 to charge the rechargeable unit 220. On the other hand, when the RFID tag 100 is not used, the interceptor 214 cuts off the connection between the power source 210 and the rechargeable unit 220 to prevent power charged in the rechargeable unit 220 from being consumed. Also, when low potential occurs in the rechargeable unit 220 during an RFID tag operation, the interceptor 214 can cut off power applied to the rechargeable unit 220. The interceptor 214 can be controlled by a control element of the RFID tag chip 100, more particularly, a reset device which detects DC voltage at the output terminal of the DC power source 211.

The RFID tag 100 according to various embodiments of the present invention will be described below.

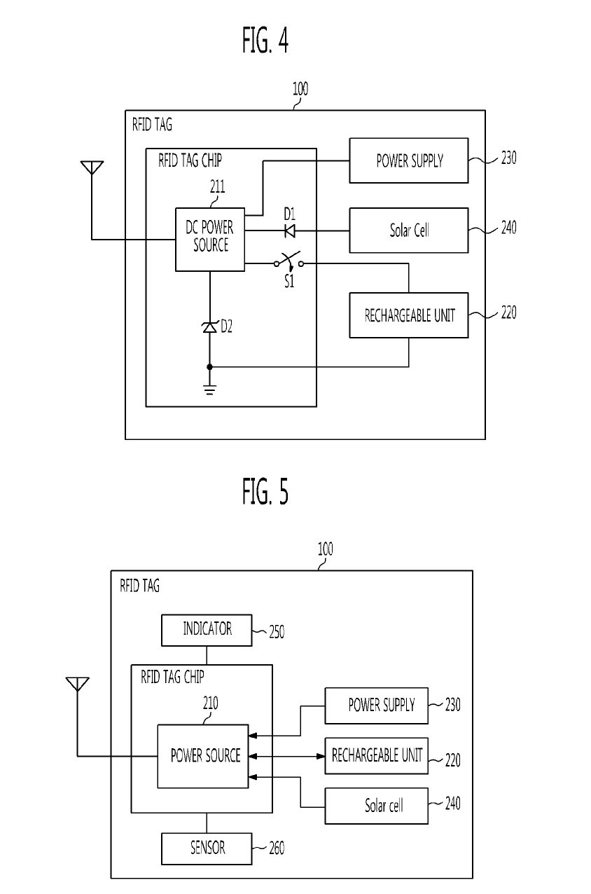

First, FIG. 3 shows a constitution of the RFID tag 100 shown in FIG. 1B to which a power supply 230 and a solar cell 240 are added. In the RFID tag 100 shown in FIG. 3, the rechargeable unit 220 can be charged by another power supply as well as RF power from an RFID reader. Power generated by the solar cell 240 is connected to the power source 210 and can charge the rechargeable unit 220. A diode (not shown) may be disposed between the solar cell 240 and the power source 210 to send the power generated by the solar cell 240 to the rechargeable unit 220 only. The solar cell 240 detects light and generates power. When little power is generated due to the size limitation of the solar cell 240, a charging circuit (e.g., diode) may be a complex charging circuit (e.g., charge pump) to charge the rechargeable unit 220. The power supply 230 can supply power to the rechargeable unit 220 through a power connector consisting of a positive power supply line and ground line. As the power connector, simply two lines can be used, or a generally-used universal serial bus (USB) connector can be used as it is. In this way, the RFID tag 100 according to an exemplary embodiment of the present invention shown in FIG. 3 can be charged by an RF and a solar cell, and directly by an external power supply.

FIG. 4 illustrates connections in the RFID tag 100 shown in FIG. 3 according to an exemplary embodiment of the present invention. The rechargeable unit 220, the power supply 230, and the solar cell 240 are each connected to an output terminal of the DC power source 211, that is, connected to the DC power source 211 in parallel overall. A switch S1 may be disposed between the rechargeable unit 220 and the DC power source 211. When the RFID tag 100 is used, the switch S1 connects the DC power source 211 and the rechargeable unit 220 to charge the rechargeable unit 220. On the other hand, when the RFID tag 100 is not used, the switch S1 cuts off the connection between the DC power source 211 and the rechargeable unit 220 to prevent power charged in the rechargeable unit 220 from being consumed. Also, when low potential occurs in the rechargeable unit 220 during an RFID tag operation, the switch S1 can cut off power applied to the rechargeable unit 220. The switch S1 can be controlled by a reset device (not shown) which detects DC voltage at the output terminal of the DC power source 211. A diode D1 may be disposed between the solar cell 240 and the DC power source 211 and operate as a switch controlling a connection between the solar cell 240 and the DC power source 211. The power supply 230 connects external power to the RFID tag 100, and can be implemented into various types of known electrical connectors such as a two-terminal connector and a USB connector. The power supply 230 is configured to charge the rechargeable unit 220 with the external power. When the power supply 230 is not connected with the external power, the power supply 230 is an open circuit and thus does not require a switch between the DC power source 211 and the power supply 230 itself A diode D2 connected to the output terminal of the DC power source 211 is connected with the rechargeable unit 220 in parallel, thereby preventing the rechargeable unit 220 from being charged to an overvoltage. The connections of the RFID tag 100 shown in FIG. 4 are simplified for clarity of description, and those of ordinary skill in the art would appreciate that the connections can be implemented using a variety of components. For example, the switch S1 and the diodes D1 and D2 shown in FIG. 4 can be CMOS circuits.

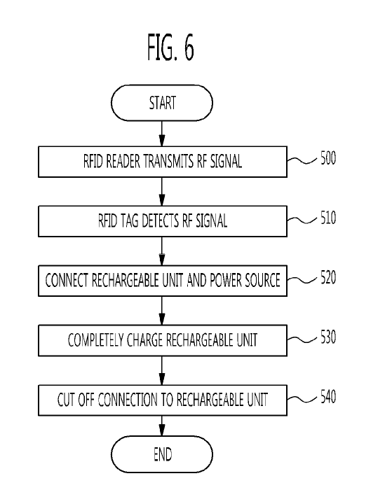

FIG. 5 shows a constitution of the RFID tag 100 shown in FIG. 3 to which an indicator 250 and a sensor 260 are added. The indicator 250 may indicate various pieces of information relating to the RFID tag 100 such as a current state and location of the RFID tag 100, and may be a light-emitting diode (LED) in an exemplary embodiment of the present invention. The sensor 260 is intended to recognize various pieces of information relating to the RFID tag 100 such as a current state and location of the RFID tag 100, and may be a temperature sensor in an exemplary embodiment of the present invention. The RFID tag 100 shown in FIG. 5 can identify a state of objects such as medical materials (e.g., blood) and groceries at a relatively long distance.

FIG. 6 is a flowchart illustrating a method of charging the rechargeable unit 220 in the RFID tag 100 according to an exemplary embodiment of the present invention. For the sake of clarity, a method of charging the rechargeable unit 220 of the RFID tag 100 shown in FIGS. 1A and 1B will be described.

When an RFID reader transmits an RF signal (step 500), the RFID tag 100 detects and receives the RF signal (step 510). In response to the reception of the RF signal, the interceptor 214 connects the rechargeable unit 220 and the power source 210 (e.g., closes a switch) (step 520). When the rechargeable unit 220 is completely charged (step 530), an overvoltage is detected, and the interceptor 214 cuts off the connection between the rechargeable unit 220 and the power source 210 (e.g., opens the switch) (step 540).

In this way, by embedding a rechargeable battery in an RFID tag on the basis of a passive RFID tag, data of the RFID tag can be stably read at a long distance.

As described above, an RFID tag according to an exemplary embodiment of the present invention can be manufactured in a small size, easily managed, and requires low cost. Also, due to a simple power supply, the RFID tag can be read at a long distance, and it is possible to prevent deterioration of a recognition rate caused by weak power.

In the future, the RFID tag according to an exemplary embodiment of the present invention can be applied to application fields such as information systems and sensor signal processing systems in various ways.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A radio frequency identification (RFID) tag, comprising:
a rechargeable unit charged to a predetermined voltage;
a direct current (DC) power source for generating power from an RF signal;
an interceptor disposed between the DC power source and the rechargeable unit, and connecting or disconnecting the power to the rechargeable unit; and
an overvoltage preventor connected to an output terminal of the DC power source and connected with the rechargeable unit in parallel to prevent the rechargeable unit from being charged to an overvoltage.

2. The RFID tag of claim 1, wherein the DC power source includes:
a rectifier for converting the RF signal received by an antenna into DC power; and
a regulator for supplying a predetermined DC voltage.

3. The RFID tag of claim 1, wherein the interceptor is a switch circuit.

4. The RFID tag of claim 1, wherein the overvoltage preventor is a diode circuit.

5. The RFID tag of claim 1, wherein the rechargeable unit is charged by the power generated by the DC power source.

6. The RFID tag of claim 1, further comprising a power supply connected to the output terminal of the DC power source,
wherein the rechargeable unit is charged by the power generated by the DC power source or external power connected through the power supply.

7. The RFID tag of claim 1, further comprising a solar cell connected to the output terminal of the DC power source,
wherein the rechargeable unit is charged by the power generated by the DC power source or power generated by the solar cell.

8. The RFID tag of claim 7, wherein a diode is disposed between the solar cell and the DC power source, and controls a power connection between the solar cell and the DC power source.

9. The RFID tag of claim 1, further comprising a power supply and a solar cell connected to the output terminal of the DC power source,
wherein the rechargeable unit is charged by the power generated by the DC power source, external power connected through the power supply, or power generated by the solar cell.

10. The RFID tag of claim 9, wherein a diode is disposed between the solar cell and the DC power source, and controls a power connection between the solar cell and the DC power source.

11. The RFID tag of claim 1, further comprising an indicator for indicating pieces of information relating to the RFID tag.

12. The RFID tag of claim 1, further comprising a sensor for recognizing pieces of information relating to the RFID tag.
